(19) United States
(12) Patent Application Publication
(10) Pub. No.: US 2014/0245408 A1
(43) Pub. Date: Aug. 28, 2014

(54) BIOMETRIC APPROACH TO TRACK CREDENTIALS OF ANONYMOUS USER OF A MOBILE DEVICE

(71) Applicant: LSI CORPORATION, San Jose, CA (US)

(72) Inventors: Prabhakar Ballapalle, Bangalore (IN); Anil Kumar Sinha, Bangalore (IN)

(73) Assignee: LSI Corporation, San Jose, CA (US)

(21) Appl. No.: 13/783,787

(22) Filed: Mar. 4, 2013

Related U.S. Application Data
(60) Provisional application No. 61/769,302, filed on Feb. 26, 2013.

(51) Int. Cl. G06F 21/00

(52) U.S. Cl. CPC G06F 21/00
USPC 726/6

(57) ABSTRACT

A system includes one or more mobile devices and a shared server. Each of the one or more mobile devices is associated with a unique identification tag and configured to send biometric information about anonymous users to a shared server space. The shared server provides the shared server space. The shared server is generally configured to store biometric information about a plurality of anonymous users associated with the unique identification tag of each of the one or more mobile devices. In response to a query about a lost or stolen mobile device, the shared server is enabled to track credentials of anonymous users associated with the unique identification tag of the lost or stolen mobile device.

### FIELD OF THE INVENTION

The invention relates to mobile security and access authentication generally and, more particularly, to a method and/or apparatus for implementing a novel biometric approach to track the credentials of an anonymous user of a mobile device.

### BACKGROUND

Conventional approaches for tracking credentials of mobile device users employ a subscriber identity module (SIM) number or international mobile station equipment identity (IMEI) number. However the conventional methods are inefficient in the case of loss or theft of mobile devices. Most of the time the mobile devices are switched off. In the case of theft, the SIM is changed immediately by the culprits. Even when the mobile devices are ON and the SIM number can be found using the IMEI number, it can still be difficult to locate the person having the mobile device if the cell size is large and/or the number of users within a cell is large.

A few alternative methods have been proposed using biometrics and tracking using the GPS data transmitted from the mobile device. However, the alternative methods also fail in the cases where the mobile device is (i) immediately switched OFF, (ii) used in locations where the cell size is large, or (iii) used in densely populated areas.

It would be desirable to have a method and/or apparatus for implementing a biometric approach to track credentials of an anonymous user of a mobile device.

### SUMMARY

The invention concerns a system including one or more mobile devices and a shared server. Each of the one or more mobile devices is associated with a unique identification tag and configured to send biometric information about anonymous users to a shared server space. The shared server provides the shared server space. The shared server is generally configured to store biometric information about a plurality of anonymous users associated with the unique identification tag of each of the one or more mobile devices. In response to a query about a lost or stolen mobile device, the shared server is enabled to track credentials of anonymous users associated with the unique identification tag of the lost or stolen mobile device.

### BRIEF DESCRIPTION OF THE FIGURES

Embodiments of the invention will be apparent from the following detailed description and the appended claims and drawings in which:

FIG. 1 is a diagram illustrating a mobile device capable of making a biometric measurement in accordance with an embodiment of the invention;

FIG. 2 is a diagram illustrating an access authentication process in accordance with an embodiment of the invention;

FIG. 3 is a diagram illustrating a system in accordance with an embodiment of the invention; and

FIG. 4 is a diagram illustrating a credential tracking process in accordance with an embodiment of the invention.

### DETAILED DESCRIPTION OF THE PREFERRED EMBODIMENTS

Embodiments of the invention include providing a biometric approach to track credentials of an anonymous user of a mobile device that may (i) record biometric information about mobile device users in a shared server space, (ii) use the biometric information stored in the shared server space to track anonymous users, (iii) use the biometric information stored the shared server space to identify anonymous users, and/or (iv) use the biometric information stored in the shared server space to track movement of a mobile device within a group of people after loss or theft of the mobile device.

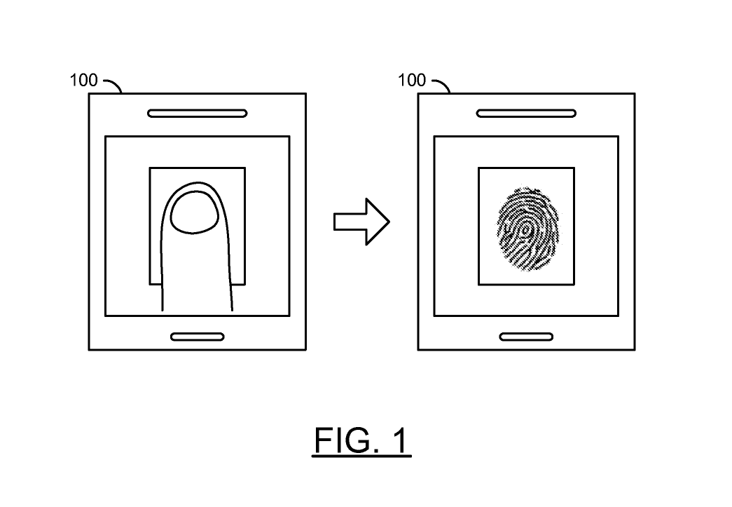

Referring to FIG. 1, a diagram is shown illustrating a mobile device capable of making a biometric measurement in accordance with an embodiment of the invention. It can be challenging to track the credentials of an anonymous user of a mobile device (e.g., cellular telephone, smart phone, satellite phone, tablet computer, personal digital assistant, portable personal computer, laptop computer, etc.) after loss or theft, even when a unique identification tag (e.g., international mobile station equipment identity (IMEI) number, media access control address (MAC address), etc.) associated with the mobile device is known. In embodiments of the invention, a biometric measurement system (e.g., fingerprint recognition system, eye iris pattern recognition system, facial feature recognition system, etc.) can be used to facilitate tracking the identity of the anonymous user of the mobile device.

Mobile device models are shipping with built-in cameras and/or fingerprint readers. The fingerprint readers can be used to restrict access to only authenticated users. In some embodiments, when an anonymous user tries to access the mobile device, after a number of trials (e.g., three), his/her recent fingerprint data is automatically sent over a network and stored in a shared server space maintained by the mobile service providers against the unique identification tag (e.g., the IMEI number, etc.) of the mobile device. In case of theft or loss, the recent anonymous users fingerprint database can be used in tracking the credentials of the anonymous users involved directly.

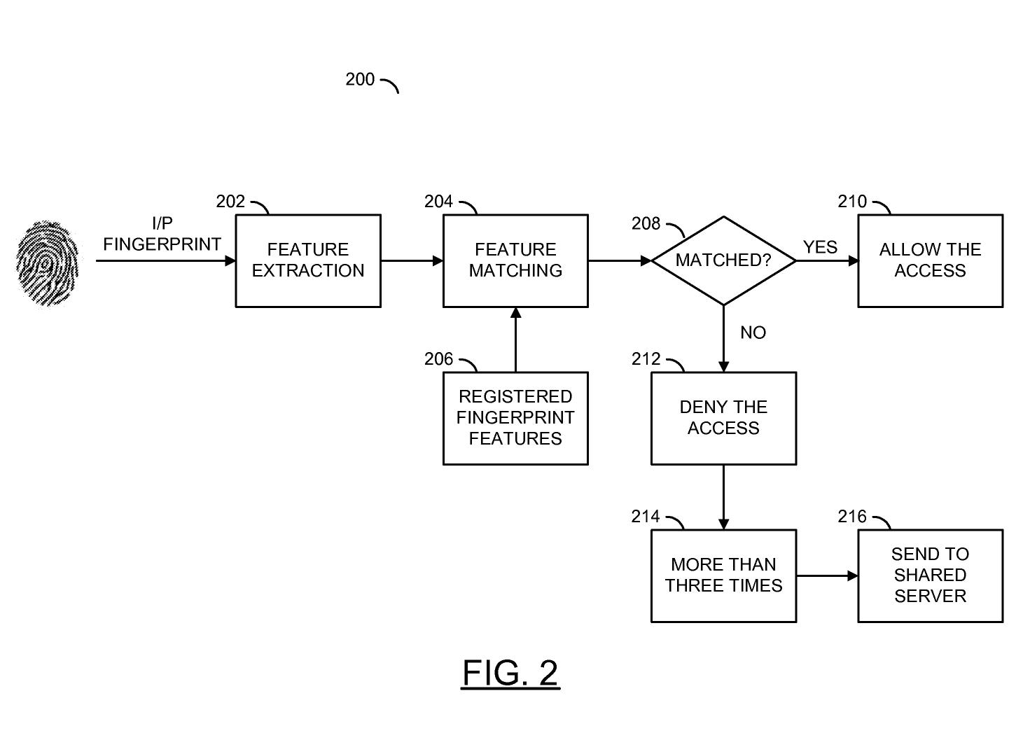

Referring to FIG. 2, a diagram is shown illustrating an access authentication process 200 in accordance with an embodiment of the invention. In some embodiments, mobile devices can include fingerprint readers and/or other biometric measurement devices for security purposes. A registered user, whose fingerprint is registered initially while purchasing the mobile device (e.g., phone, etc.), is the owner/administrator of the mobile device. The owner/administrator of the mobile device can allow other users, called “permitted users,” to have either full access or limited access to applications and data, as per his/her choice, by registering the fingerprints of the permitted users. The fingerprint reader scans the input and if the input matches the registered fingerprints in the mobile device, the mobile device allows the access. Otherwise, the access is denied. After a predetermined number of denials, the recent fingerprint data (and/or other biometric measurement data) can be automatically sent over a network and stored in a shared server space maintained by the mobile service providers against the unique identification tag (e.g., the IMEI number, etc.) of the mobile device.

In some embodiments, the process (or method) 200 comprises a step (or state) 202, a step (or state) 204, a step (or state) 206, a step (or state) 208, a step (or state) 210, a step (or state) 212, a step (or state) 214, a step (or state) 216. In the step 202, a fingerprint is input and features extracted. The process 200 then moves to the step 204. In the step 204, the process 200 performs feature matching using the features extracted in the step 202 and registered fingerprint features 206. When the feature matching is finished, the process 200 moves to the step 208. If there is a match between the features extracted in the step 202 and the registered fingerprint features 206, the process 200 moves to the step 210 and allows the access. If there is no match between the features extracted in the step 202 and the registered fingerprint features 206, the process 200 moves to the step 212, where the process 200 denies the access, then moves to the step 214. In the step 214, the process 200 determines whether access has been denied more than the predetermined number of times (e.g., three). If so, the fingerprint features extracted in the step 202 are sent to a shared server space for storage. It will be apparent to those skilled in the art that the process 200 can be applied equally well to other biometric measurements (e.g., eye iris patterns, facial features, etc.). In some embodiments, the number of times access is denied before sending the extracted feature data to the shared server space may be programmable (e.g., at activation, by the user, etc.).

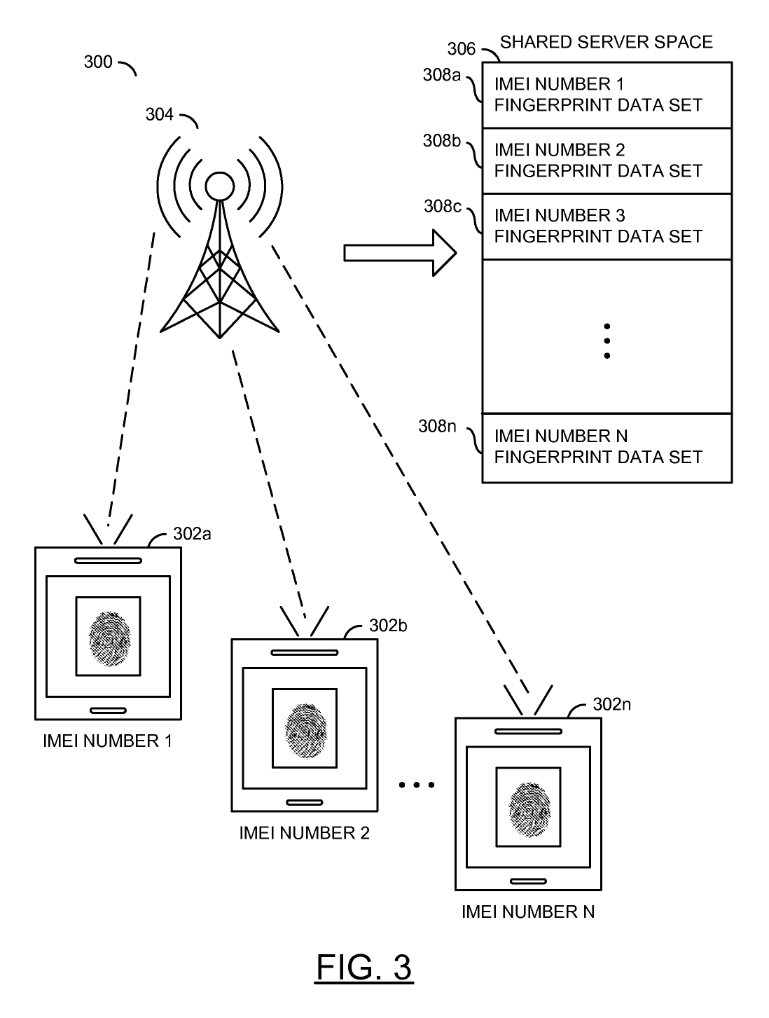

Referring to FIG. 3, a diagram is shown illustrating a system 300 in accordance with an embodiment of the invention. In some embodiments, the system 300 comprises a number of mobile devices 302a-302n. The mobile devices 302a-302n are generally in communication with a base station 304. The base station 304 is generally in communication with a shared server space 306. In some embodiments, the system 300 is implemented as a cellular telephone system. For example, the system 300 may be implemented as a universal mobile telecommunications system (UMTS), with each of the mobile devices 302a-302n implementing user equipment (UE) and the base station 304 implementing Node B/eNodeB. However, other cellular specifications may be implemented accordingly to meet the design criteria of a particular implementation (e.g., evolved universal terrestrial radio access (E-UTRA), 3rd Generation Partnership Project (3GPP) long term evolution (LTE), etc.). In some embodiments, when an anti-theft and tracking feature of the mobile devices 302a-302n is enabled, after a predetermined number of attempts (e.g., three) by an anonymous user to access one of the mobile devices using his/her fingerprint, the recent fingerprint data is automatically sent to the shared server space 306. The fingerprint data on the shared server can greatly help in tracking and obtaining the credentials of a person even if the mobile device is switched off after the three attempts because his/her fingerprint features are already stored in the shared server space 306. In some embodiments, the shared server space 306 is implemented with provision for storing a fingerprint set with each unique identification tag (e.g., IMEI numbers 1-N). Each fingerprint set can comprise a number (e.g., M) of anonymous user fingerprints. In some embodiments, the number of anonymous user fingerprints stored in each fingerprint set is 10. The storing of 10 anonymous fingerprints in the shared server space 306 is generally sufficient to help in tracking the movement of a mobile device within a group of people after loss or theft. However, sets with other numbers of anonymous fingerprints may be implemented accordingly to meet the design criteria of a particular implementation.

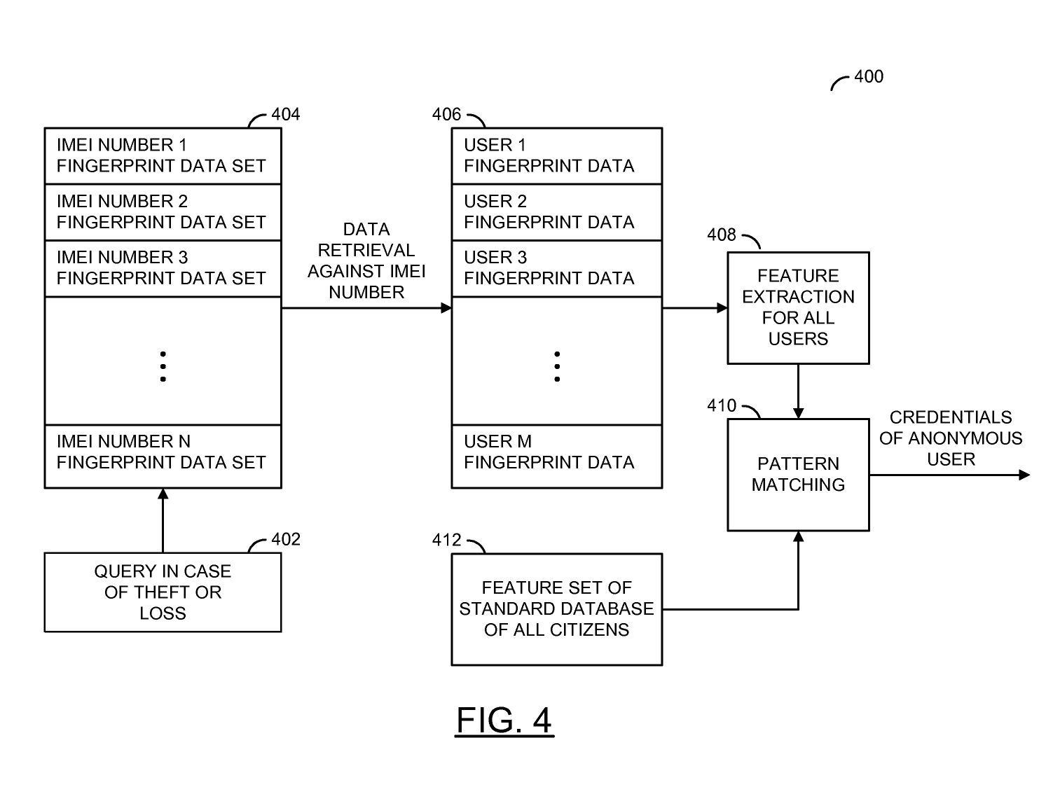

Referring to FIG. 4, a diagram is shown illustrating a process 400 for tracking the credentials of an anonymous user in accordance with an embodiment of the invention. In some embodiments, the process (or method) 400 comprises a step (or state) 402, a step (or state) 404, a step (or state) 406, a step (or state) 408, a step (or state) 410, and a step (or state) 412. In the step 402, a query is initiated in the case of loss or theft of a mobile device. The process then moves to the step 404 where the shared server space is searched for a fingerprint data set associated with the IMEI number of the lost or stolen mobile device. The process 400 retrieves the data associated with the IMEI and moves to the step 406. In the step 406, fingerprint data for all anonymous users of the mobile device are identified. In the step 408, fingerprint features are extracted for all the anonymous users. In the step 410, the process 400 performs pattern matching of the features extracted in the step 408 against feature sets in available databases of citizens (available in most of the developed countries) for getting the exact credentials of the person. It will be apparent to those skilled in the art that the process 400 can be applied equally well to other biometric measurements (e.g., eye iris patterns, facial features, etc.).

The functions illustrated by the diagrams of FIGS. 1-4 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMS (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. A system comprising:
one or more mobile devices, each of said one or more mobile devices associated with a unique identification tag and configured to send biometric information about anonymous users to a shared server space;
a shared server providing said shared server space, said shared server configured to store biometric information about a plurality of anonymous users associated with the unique identification tag of each of said one or more mobile devices, wherein in response to a query about a lost or stolen mobile device said shared server is enabled to track credentials of anonymous users associated with the unique identification tag of the lost or stolen mobile device.

2. The system according to claim 1, wherein said one or more mobile devices comprise a cellular telephone.

3. The system according to claim 1, wherein said one or more mobile devices comprise one or more of a tablet computer, a personal digital assistant, a smartphone, a personal computer, and a laptop computer.

4. The system according to claim 1, wherein said system comprises a cellular telephone network.

5. The system according to claim 1, wherein said system comprises one or more of a universal mobile telecommunications system (UMTS), an evolved universal terrestrial radio access (E-UTRA) system, and a 3GPP LTE compliant cellular telephone network.

6. The system according to claim 1, wherein said unique identification tag comprises an international mobile station equipment identity (IMEI) number.

7. The system according to claim 1, wherein said biometric information comprises a fingerprint features.

8. The system according to claim 1, wherein each of said one or more mobile devices comprises a fingerprint scanner.

9. The system according to claim 1, wherein said biometric information comprises eye iris pattern features.

10. The system according to claim 1, further comprising one or more databases of biometric information of individuals.

11. The system according to claim 1, wherein transmission of said biometric information about said anonymous users to said shared server space is enabled when an anti-theft and tracking feature of said one or more mobile devices is enabled.

12. The system according to claim 1, wherein said one or more mobile devices are configured to transmit said biometric information about said anonymous users to said shared server space after a predetermined number of access denials.

13. A method of tracking credentials of an anonymous user of a mobile device comprising:
making a biometric measurement of anonymous users of a mobile device;
sending said biometric information about said anonymous users to a shared server space;
associating said biometric information about said anonymous users in said shared server space with a unique identification tag of said mobile device;
tracking credentials of anonymous users associated with the unique identification tag of a lost or stolen mobile device in response to a query about the lost or stolen mobile device.

14. The method according to claim 13, wherein said unique identification tag comprises an international mobile station equipment identity (IMEI) number.

15. The method according to claim 13, wherein the step of making said biometric measurement of said anonymous users of said mobile device comprises using a fingerprint scanner to collect fingerprint features of said anonymous users.

16. The method according to claim 13, wherein the step of making said biometric measurement of said anonymous users of said mobile device comprises scanning eye iris pattern features of said anonymous users.

17. The method according to claim 16, wherein scanning said eye iris pattern features of said anonymous users is performed using a camera of said mobile device.

18. The method according to claim 13, further comprising:
enabling transmission of said biometric information about anonymous users to said shared server space when an anti-theft and tracking feature of said mobile device is enabled; and
disabling transmission of said biometric information about anonymous users to said shared server space when an anti-theft and tracking feature of said mobile device is not enabled.
